(19) United States
(12) Patent Application Publication
(10) Pub. No.: US 2013/0223898 A1
(43) Pub. Date: Aug. 29, 2013

(54) IMAGE FORMING APPARATUS

(71) Applicant: FUJI XEROX CO., LTD., (US)

(72) Inventors: Masahiro SATO, Kanagawa (JP); Atsuyuki KITAMURA, Kanagawa (JP); Atsushi OGIHARA, Kanagawa (JP); Tetsuji OKAMOTO, Kanagawa (JP); Koichi WATANABE, Kanagawa (JP); Wataru SUZUKI, Kanagawa (JP); Shuichi NISHIDE, Kanagawa (JP)

(73) Assignee: FUJI XEROX CO., LTD., Tokyo (JP)

(21) Appl. No.: 13/656,124

(22) Filed: Oct. 19, 2012

(30) Foreign Application Priority Data
Feb. 29, 2012 (JP) 2012-044202

(51) Int. Cl. G03G 15/01

(52) U.S. Cl. 399/304

(57) ABSTRACT

An image forming apparatus includes an image carrier that carries a developer image, a recording-medium transporting member that includes a holding portion that holds a leading end of a recording medium wrapped around the recording-medium transporting member, a retaining portion that switches between a state in which the retaining portion retains a trailing end portion of the recording medium and a state in which the retaining portion does not retain the trailing end portion, a position adjusting unit that adjusts the position at which the retaining portion retains the trailing end portion, a transfer unit that transfers the developer image onto the recording medium, a determination unit that determines a thickness of the recording medium, and a control unit that causes the retaining portion to retain the trailing end portion at a position adjusted by the position adjusting unit in accordance with the thickness of the recording medium.

### CROSS-REFERENCE TO RELATED APPLICATIONS

This application is based on and claims priority under 35 USC 119 from Japanese Patent Application No. 2012-044202 filed Feb. 29, 2012.

### BACKGROUND

The present invention relates to an image forming apparatus.

### SUMMARY

According to an aspect of the invention, there is provided an image forming apparatus including an image carrier, a recording-medium transporting member, a retaining portion, a position adjusting unit, a transfer unit, a determination unit, a control unit. The image carrier that is rotatably provided and carries a developer image. The recording-medium transporting member is rotatably provided so as to face the image carrier and includes a holding portion that holds a leading end of a recording medium, the recording medium being wrapped around an outer peripheral surface of the recording-medium transporting member. The retaining portion switches between a state in which the retaining portion retains a trailing end portion of the recording medium that is wrapped around the recording-medium transporting member and a state in which the retaining portion does not retain the trailing end portion of the recording medium. The position adjusting unit adjusts the position at which the retaining portion retains the trailing end portion of the recording medium in a circumferential direction of the recording-medium transporting member. The transfer unit transfers the developer image carried by the image carrier onto the recording medium retained on the recording-medium transporting member. The determination unit determines a thickness of the recording medium. The control unit performs a control for causing the retaining portion to retain the trailing end portion of the recording medium at a position adjusted by the position adjusting unit in accordance with the thickness of the recording medium determined by the determination unit.

### BRIEF DESCRIPTION OF THE DRAWINGS

Exemplary embodiments of the present invention will be described in detail based on the following figures, wherein:

FIG. 1 illustrates the overall structure of an image forming apparatus according to an exemplary embodiment of the present invention;

FIG. 2A illustrates a leading-end gripper and a trailing-end gripper in a plan view of a transfer drum according to the exemplary embodiment of the present invention;

FIG. 2B illustrates the transfer drum according to the exemplary embodiment of the present invention viewed in an axial direction;

FIGS. 3A and 3B illustrate the trailing-end gripper according to the exemplary embodiment of the present invention in an open state and a closed state, respectively;

FIGS. 4A, 4B, 4C, and 4D illustrate a transporting operation in which a sheet of recording paper is transported by the transfer drum according to the exemplary embodiment of the present invention;

FIG. 5A is a block diagram of a system including a controller for controlling a trailing-end-gripper driver and an exposure device according to the exemplary embodiment of the present invention;

FIG. 5B is a schematic diagram illustrating a setting panel according to the exemplary embodiment of the present invention;

FIG. 6A illustrates a method for measuring a spring-back force of a trailing end of a sheet of recording paper that is wrapped around an outer peripheral surface of the transfer drum according to the exemplary embodiment of the present invention;

FIG. 6B is a schematic diagram illustrating uniformly distributed load used to determine a tension required to be applied to the trailing-end gripper according to the exemplary embodiment of the present invention;

FIG. 7A is a table showing the spring-back force of each type of recording paper according to the exemplary embodiment of the present invention;

FIG. 7B is a graph showing the relationship between the separation distance and the tension of the trailing-end gripper for each type of recording paper according to the exemplary embodiment of the present invention;

FIG. 8A is a schematic diagram illustrating the manner in which the trailing-end gripper is disposed at the trailing end of a sheet of normal paper according to the exemplary embodiment of the present invention;

FIG. 8B is a schematic diagram illustrating the manner in which the trailing-end gripper is disposed at the trailing end of a sheet of thick paper according to the exemplary embodiment of the present invention;

FIG. 8C is a schematic diagram illustrating the manner in which the trailing-end gripper is disposed at the trailing end of an envelope with a flap at the right side thereof according to the exemplary embodiment of the present invention;

FIG. 9A is a schematic diagram illustrating the manner in which the trailing-end gripper is disposed at the trailing end of an envelope with a flap at the bottom thereof according to the exemplary embodiment of the present invention;

FIG. 9B is a schematic diagram illustrating the manner in which the trailing-end gripper is disposed at the trailing end of an envelope with a flap at the right side thereof according to the exemplary embodiment of the present invention;

FIG. 10A illustrates a normal image forming area in the image forming apparatus according to the exemplary embodiment of the present invention;

FIG. 10B illustrates a reduced image forming area for when the trailing-end gripper is moved according to the exemplary embodiment of the present invention;

FIG. 10C illustrates the state in which an image is partially cut in accordance with the position of the trailing-end gripper according to the exemplary embodiment of the present invention;

FIG. 10D illustrates the state in which an image is reduced in accordance with the position of the trailing-end gripper according to the exemplary embodiment of the present invention;

FIG. 11A is a schematic diagram illustrating the state in which a sheet of recording paper is retained while being wrapped around the outer peripheral surface of the transfer drum according to the exemplary embodiment of the present invention; and

FIG. 11B is a schematic diagram illustrating the state in which a sheet of recording paper cannot be retained while being wrapped around an outer peripheral surface of a transfer drum according to a comparative example.

### DETAILED DESCRIPTION

An image forming apparatus according to an exemplary embodiment of the present invention will now be described.

### Overall Structure

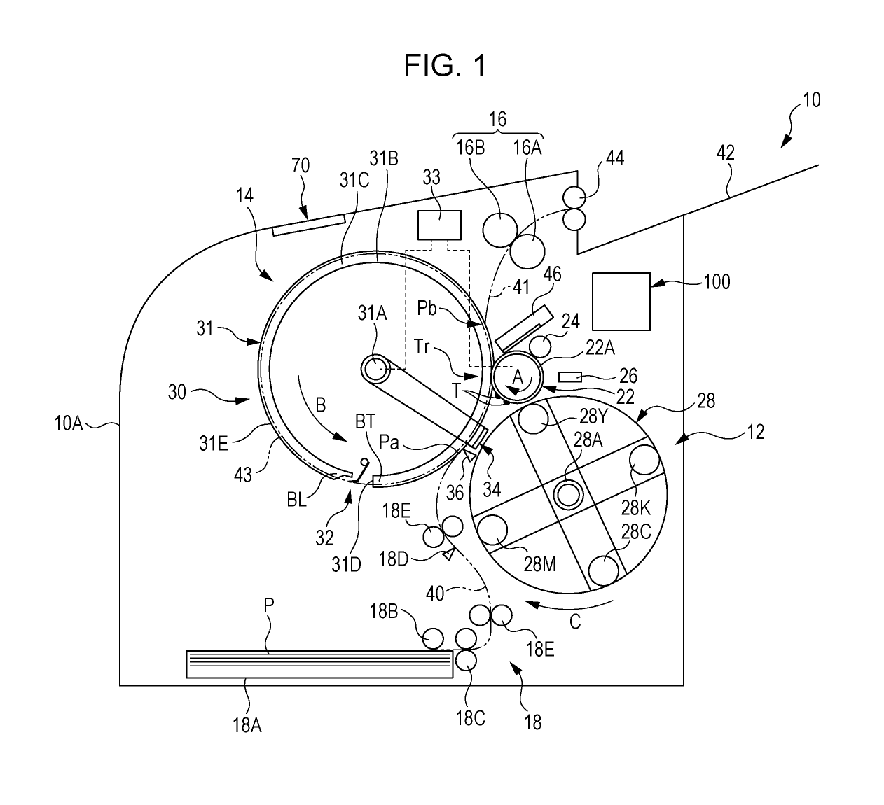

FIG. 1 illustrates an image forming apparatus 10 according to the exemplary embodiment of the present invention. The image forming apparatus 10 includes an image forming unit 12, a paper feed unit 18, a transfer device 14, a fixing device 16, and a controller 100, which is an example of a control unit. The image forming unit 12 forms a toner image T, which is an example of a developer image. The paper feed unit 18 feeds and transports a sheet of recording paper P, which is an example of a recording medium. The transfer device 14 transfers the toner image T formed by the image forming unit 12 onto the sheet of recording paper P while retaining the sheet of recording paper P. The fixing device 16 fixes the toner image T to the sheet of recording paper P after the sheet of recording paper P is released from the transfer device 14. The controller 100 controls the overall operation (operation of each part) of the image forming apparatus 10. A housing 10A that serves as an apparatus body houses components of the image forming apparatus 10. A paper receiver 42, which receives the sheet of recording paper P that has been ejected from the fixing device 16, is provided at the top of the housing 10A.

The image forming unit 12 includes the photoconductor drum 22, a charging device 24, an exposure device 26, a developing device 28, and a cleaning device 46. The photoconductor drum 22 is an example of an image carrier, and is rotatable. The charging device 24 charges the photoconductor drum 22. The exposure device 26 subjects the photoconductor drum 22 in the charged state to an exposure process. The developing device 28 performs a developing process by using toner (not shown), which is an example of developer. The cleaning device 46 removes the toner that remains on the photoconductor drum 22 after a transfer process from the photoconductor drum 22.

The photoconductor drum 22 includes a photosensitive layer 22A having, for example, a negative charge polarity, on the outer peripheral surface thereof. The photoconductor drum 22 may be rotated in the direction of arrow A (clockwise in FIG. 1) by a driving unit (not shown) including a motor. The outer diameter of the photoconductor drum 22 is, fore example, 30 mm. The photoconductor drum 22 is grounded. The charging device 24, the exposure device 26, the developing device 28, and the cleaning device 46 are arranged so as to face the photosensitive layer 22A (outer peripheral surface) of the photoconductor drum 22 in that order in the direction of arrow A.

The charging device 24 is, for example, a contact roller discharge device, and discharges electricity when a voltage is applied to the charging device 24 by a voltage applying unit (not shown) and a potential difference is generated between the charging device 24 and the photoconductor drum 22, which is grounded. The charging device 24 charges the photoconductor drum 22 while rotating together with the photoconductor drum 22.

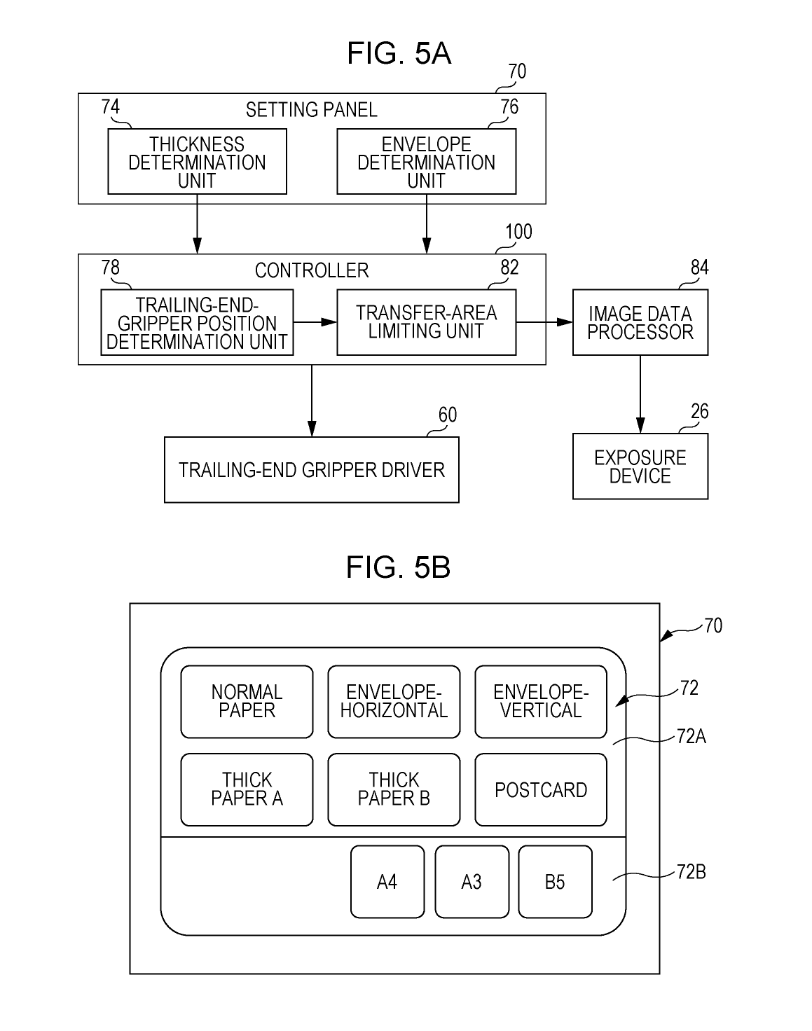

The exposure device 26 forms an electrostatic latent image by irradiating the charged surface of the photoconductor drum 22 with light on the basis of image data (image information) transmitted from an image data processor (see FIG. 5A), which will be described below. The exposure device 26 includes, for example, an array of LEDs (not shown), which serve as light sources, and distributed index lenses (not shown).

The developing device 28 is a rotary developing device that has a columnar shape. The developing device 28 includes a rotating shaft 28A, whose axial direction coincides with that of a rotating shaft (not shown) of the photoconductor drum 22, and yellow (Y), magenta (M), cyan (C), and black (K) developing units 28Y, 28M, 28C, and 28K which are arranged around the rotating shaft 28A at an angular pitch of 90°. The developing device 28 is detachably attached to the housing 10A. The developing device 28 is configured to rotate around the rotating shaft 28A in the direction of arrow C (clockwise in FIG. 1).

In the case where only single-color images are to be formed instead of color images (multicolor images), the developing device 28 may be replaced by a developing device that includes only a developing unit for a single color (for example, only the black (K) developing unit 28K). The developing device 28 is configured such that one of the developing units 28Y, 28M, 28C, and 28K is stopped at the position where the developing device 28 faces the outer peripheral surface of the photoconductor drum 22. Thus, the developing device 28 develops the electrostatic latent image that has been formed on the photoconductor drum 22 by the exposure device 26 with toner. The outer diameter of the developing device 28 is, for example, 100 mm.

Each of the developing units 28Y, 28M, 28C, and 28K contains, for example, single-component developer (not shown) which includes only non-magnetic toner. Although the single-component developer is used as an example in the present exemplary embodiment, two-component toner including magnetic toner and carrier may instead be used. In the following description, the single-component developer is simply referred to as developer.

The cleaning device 46 includes, for example, a blade-type cleaner and removes with a blade the developer and substances other than the developer that remain on the outer peripheral surface of the photoconductor drum 22 after the transfer process.

A feed path 40 and an output path 41 are provided in the housing 10A. The feed path 40 is provided for transporting a sheet of recording paper P from a paper container 18A, which will be described below, to a transfer region Tr. The output path 41 is used to eject the sheet of recording paper P onto which the toner image T has been transferred to the paper receiver 42 through the fixing device 16. In the present exemplary embodiment, the sheet of recording paper P that has been transported to the transfer drum 30, which will be described below, is rotated while being wrapped around the transfer drum 30 by a leading-end gripper 32 and a trailing-end gripper 34, which will be described below. The path along which the sheet of recording paper P is transported in this manner is referred to as a rotating path 43.

The paper feed unit 18 includes the paper container 18A, a pick-up roller 18B, and a paper size sensor (not shown). The paper container 18A is disposed in a lower section of the image forming apparatus 10, more specifically, below the transfer drum 30, which will be described in detail below, and contains sheets of recording paper P. The pick-up roller 18B picks up the sheets of recording paper P from the paper container 18A. The paper size sensor is provided on the pick-up roller 18B and detects the size of the sheets of recording paper P contained in the paper container 18A. The paper feed unit 18 also includes separation rollers 18C that separate the sheets of recording paper P from each other, a registration sensor 18D that is provided on the feed path 40 and used to transport the sheets of recording paper P at a set timing, and transport rollers 18E that transport the sheets of recording paper P.

A paper detection sensor 36 is disposed near the feed path 40. The paper detection sensor 36 is arranged so as to face the outer peripheral surface of the transfer drum 30 with the feed path 40 provided therebetween. The paper detection sensor 36 detects passage of each sheet of recording paper P that is transported while being wrapped around the transfer drum 30. More specifically, the paper detection sensor 36 emits near-infrared light toward the outer peripheral surface of the transfer drum 30 and receives reflected light (near-infrared light) from the outer peripheral surface of the transfer drum 30 or the sheet of recording paper P retained by the transfer drum 30. The paper detection sensor 36 detects passage of the leading and trailing ends of the sheet of recording paper P in the transporting direction by detecting a change in the intensity of the reflected light.

The paper detection sensor 36 is disposed upstream of a standby position of the trailing-end gripper 34, which will be described below, in the transporting direction of the sheet of recording paper P. In the present exemplary embodiment, for example, the paper detection sensor 36 is disposed between the standby position of the trailing-end gripper 34 and a paper feed position Pa of the sheet of recording paper P, which will be described below. The paper detection sensor 36 also measures the rotational position of the transfer drum 30 that rotates by detecting marks (not shown) formed on the outer peripheral surface of an end portion of the transfer drum 30 in the axial direction.

The fixing device 16 is provided on the output path 41 and includes, for example, a heating roller 16A and a pressing roller 16B. The heating roller 16A is rotatable and a heat source (not shown) including, for example, a halogen lamp is disposed in the heating roller 16A. The pressing roller 16B is rotatable and has an axial direction that coincides with that of the heating roller 16A. The pressing roller 16B presses the sheet of recording paper P against the outer peripheral surface of the heating roller 16A. Paper output rollers 44 are disposed downstream of the fixing device 16 in the transporting direction of the sheet of recording paper P.

### Structure of Relevant Part

The transfer device 14 will now be described.

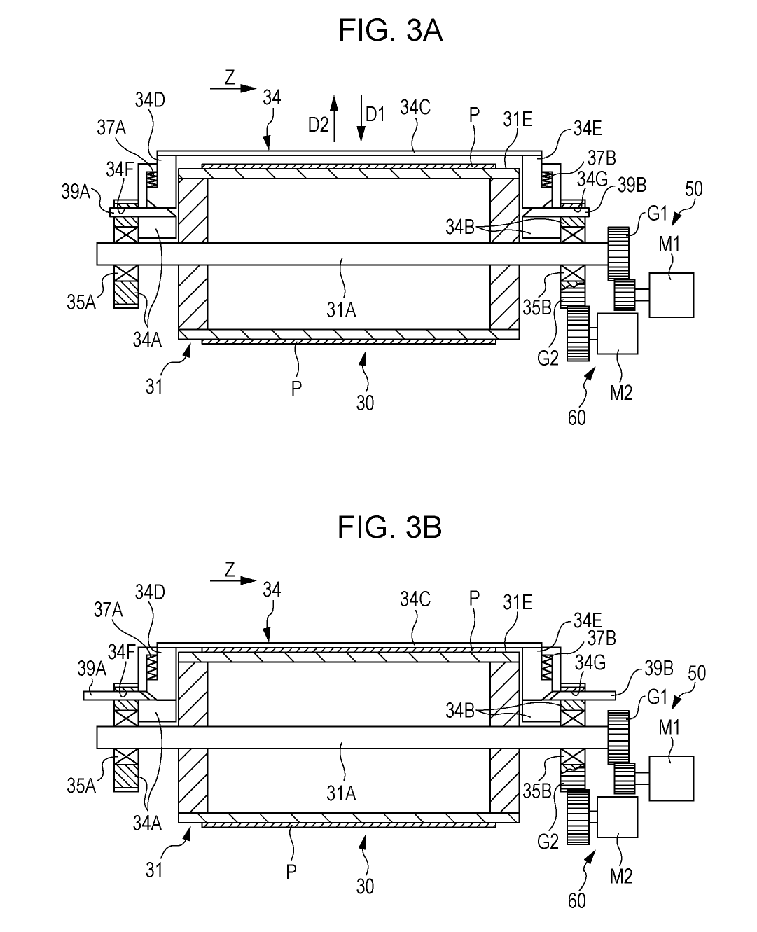

Referring to FIG. 1, the transfer device 14 includes the transfer drum 30, a transfer-drum driver 50 (see FIG. 3A), and a transfer-bias applying unit 33. The transfer drum 30 is an example of a recording-medium transporting member that retains the sheet of recording paper P. The transfer-drum driver 50 rotates the transfer drum 30. The transfer-bias applying unit 33 is an example of a transfer unit that transfers the toner image T, which is formed on the photoconductor drum 22 that faces the outer peripheral surface of the transfer drum 30, onto the sheet of recording paper P that is transported by the transfer drum 30 that is rotated by the transfer-drum driver 50. The transfer device 14 further includes the paper detection sensor 36, which detects passage of the sheet of recording paper P.

The transfer drum 30 includes a cylindrical portion 31, the leading-end gripper 32, and the trailing-end gripper 34. The sheet of recording paper P is wrapped around an outer peripheral surface 31E of the cylindrical portion 31. The leading-end gripper 32 is an example of a holding portion that holds a leading-end portion of the sheet of recording paper P. The trailing-end gripper 34 is an example of a retaining portion that retains a trailing-end portion of the sheet of recording paper P.

The outer peripheral surface 31E of the cylindrical portion 31 faces the outer peripheral surface of the photoconductor drum 22. The cylindrical portion 31 is rotatable around the rotating shaft 31A, and is detachable from the housing 10A. The cylindrical portion 31 includes a cylindrical base 31B and an elastic layer 31C that is formed on the outer peripheral surface of the base 31B. More specifically, the elastic layer 31C extends along the outer peripheral surface of the base 31B from a leading-end portion BL to a trailing-end portion BT of the elastic layer 31C in the transporting direction of the sheet of recording paper P. The cylindrical portion 31 has a cut portion 31D that is recessed in the radial direction and at which the base 31B is exposed.

The cylindrical portion 31 is configured to rotate in the direction of arrow B (counterclockwise in FIG. 1) at a peripheral speed that is slightly different from that of the photoconductor drum 22 while the elastic layer 31C is elastically deformed so as to form a nip portion between the elastic layer 31C and the photoconductor drum 22. The rotating shaft (not shown) of the photoconductor drum 22 and the rotating shaft 31A of the cylindrical portion 31 are rotatably supported by the housing 10A. The distance between the rotating shafts of the photoconductor drum 22 and the cylindrical portion 31 is maintained. For example, the outer diameter of the cylindrical portion 31 is greater than that of the photoconductor drum 22 and is 120 mm.

The base 31B of the cylindrical portion 31 is, for example, a conductive hollow tube made of a metal. The elastic layer 31C is a semiconductive elastic member and is made of rubber, such as polyurethane, chloroprene, ethylene propylene rubber (EPDM), or nitrile rubber (NBR). For example, the elastic layer 31C is made of polyurethane. The elastic layer 31C has no dielectric, such as a dielectric sheet, on the outer peripheral surface thereof. The peripheral length of the cylindrical portion 31 (the peripheral length of the elastic layer 31C) is greater than the maximum print length, that is, the maximum length of an image formed on the sheet of recording paper P by the image forming apparatus 10 in the transporting direction of the sheet of recording paper P.

The transfer-bias applying unit 33 applies a transfer bias, which is a voltage having a polarity opposite to that of the toner, to the base 31B. Accordingly, the toner image T on the photoconductor drum 22 is transferred onto the sheet of recording paper P on the elastic layer 31C in the transfer region Tr. The transfer region Tr is a region in which the photoconductor drum 22 and the transfer drum 30 face or oppose each other and in which the photoconductor drum 22 and the transfer drum 30 may be in contact with each other to transfer the toner image T on the photoconductor drum 22 onto the sheet of recording paper P on the elastic layer 31C.

The leading-end gripper 32 and the trailing-end gripper 34 are rotatable together with the transfer drum 30, and are configured to retain the sheet of recording paper P on the transfer drum 30. The leading-end gripper 32 and the trailing-end gripper 34 will now be described in detail.

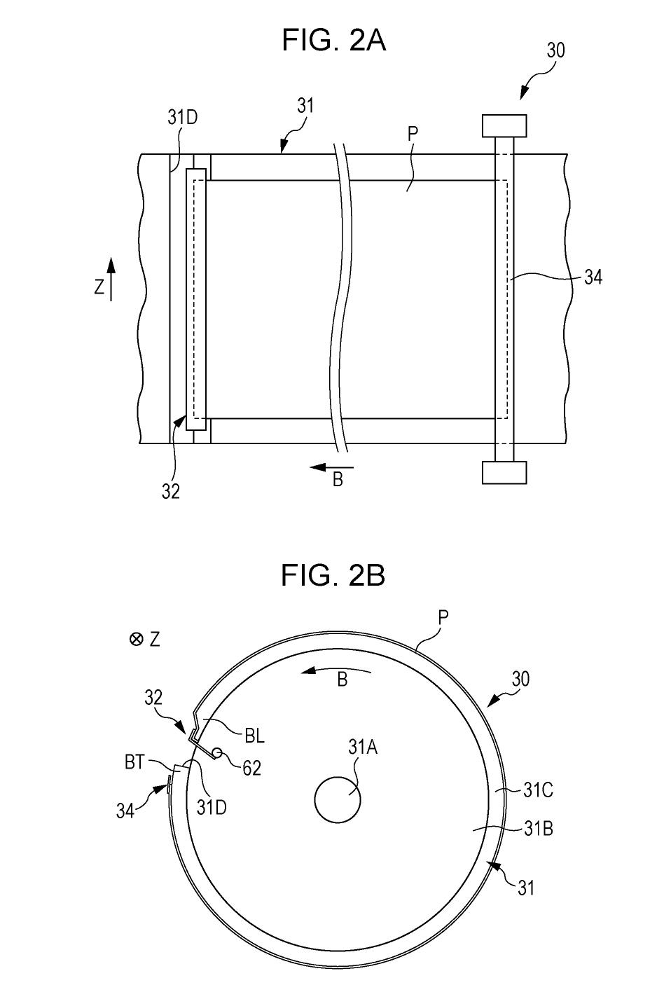

As illustrated in FIGS. 2A and 2B, the leading-end portion of the sheet of recording paper P in the transporting direction (direction of arrow B) thereof, that is, the left end portion of the sheet of recording paper P in FIG. 2A, is held by the leading-end gripper 32 on the transfer drum 30. The trailing-end portion of the sheet of recording paper P in the transporting direction thereof, that is, the right end portion of the sheet of recording paper P in FIG. 2A, is retained by the trailing-end gripper 34. The leading-end gripper 32 is fixed to the transfer drum 30.

The trailing-end gripper 34 is formed separately from the transfer drum 30 (see FIG. 1), and the position of the trailing-end gripper 34 that faces the transfer drum 30 is changeable. The leading-end gripper 32 holds the sheet of recording paper P so as to restrain the sheet of recording paper P from being displaced in the transporting direction and from moving away from the transfer drum 30. The trailing-end gripper 34 retains the sheet of recording paper P so as to allow the sheet of recording paper P to be displaced in the transporting direction but restrain the sheet of recording paper P from moving away from the transfer drum 30.

### Leading-End Gripper

The leading-end gripper 32 will now be described.

As illustrated in FIG. 3B, the leading-end gripper 32 is disposed in the cut portion 31D of the transfer drum 30. One end of the leading-end gripper 32 is connected to the cylindrical portion 31. The other end of the leading-end gripper 32 moves relative to the cylindrical portion 31 so as to hold the sheet of recording paper P that enters the space between the leading-end gripper 32 and the cylindrical portion 31.

More specifically, the leading-end gripper 32 is made of, for example, a stainless steel (SUS) and is disposed between the trailing-end portion BT and the leading-end portion BL of the elastic layer 31C. The leading-end gripper 32 is configured so as not to contact the photoconductor drum 22 (see FIG. 1) irrespective of whether the leading-end gripper 32 is in the open state or closed state. The cylindrical portion 31 is provided with columnar pins 62 that project outward in an axial direction of the rotating shaft 31A (hereinafter referred to as “Z direction”) at both ends of the cylindrical portion 31 in the Z direction. The leading-end gripper 32 is supported so as to be movable (pivotable) around the pins 62.

A tension spring (not shown) is provided such that one end thereof is fixed to the cylindrical portion 31 and the other end thereof is connected to the leading-end gripper 32. The leading-end gripper 32 holds the sheet of recording paper P together with the leading-end portion BL of the elastic layer 31C by being moved toward the leading-end portion BL by the tension of the tension spring.

Although not illustrated, the leading-end gripper 32 extends toward the inside of the cylindrical portion 31 beyond the position at which the leading-end gripper 32 is connected to each pin 62. A solenoid (not shown) is provided on the extending portion of the leading-end gripper 32 at the same side as the tension spring (not shown). The solenoid operates so as to move the extending portion in a direction such that the tension spring is stretched. Thus, the leading-end gripper 32 may be maintained in the open state even when the tension of the tension spring is applied. The leading-end gripper 32 opens toward the downstream side in the transporting direction of the sheet of recording paper P. When the solenoid returns to the original position, the leading-end gripper 32 is closed by the tension of the tension spring.

### Trailing-End Gripper

The trailing-end gripper 34 will now be described.

As illustrated in FIGS. 3A and 3B, the trailing-end gripper 34 is formed in an angular U-shape so as to extend over the transfer drum 30 in the Z direction. The trailing-end gripper 34 includes disc-shaped shaft portions 34A and 34B, whose axial directions coincide with the Z direction, at both ends of the trailing-end gripper 34 in the Z direction. Bearings 35A and 35B are provided on the radially inner sides of the shaft portions 34A and 34B, respectively. The rotating shaft 31A is inserted through the bearings 35A and 35B. Therefore, the trailing-end gripper 34 is rotatable around the rotating shaft 31A independently of the transfer drum 30.

The trailing-end gripper 34 includes a rectangular paper retainer 34C and support portions 34D and 34E. The paper retainer 34C faces the outer peripheral surface 31E of the transfer drum 30 and retains the sheet of recording paper P. The support portions 34D and 34E are provided at both ends of the paper retainer 34C in the Z direction and extend in the radial direction of the transfer drum 30.

The paper retainer 34C extends along the rotating shaft 31A of the transfer drum 30. The length of the paper retainer 34C is greater than the maximum width of the sheet of recording paper P that may be used in the image forming apparatus 10 (see FIG. 1), that is, the dimension of the sheet of recording paper P in the direction parallel to the rotating shaft 31A in the state in which the sheet of recording paper P is wrapped around the outer peripheral surface of transfer drum 30. The paper retainer 34C comes into contact with the photoconductor drum 22 in the transfer region Tr (see FIG. 1). Therefore, preferably, the paper retainer 34C is thin and has no corner portions.

The shape of the paper retainer 34C may be, for example, a film shape, a wire shape, or a columnar shape. The paper retainer 34C is made of a resin, such as polyethylene terephthalate (PET), polyimide, or fluorocarbon resin. Here, for example, the paper retainer 34C is made of polyimide. The paper retainer 34C is stretched between the support portions 34D and 34E at a tension described below.

The support portions 34D and 34E face each other with a gap therebetween, the gap being larger than the maximum width of the sheet of recording paper P that may be used in the image forming apparatus 10 (see FIG. 1). The support portions 34D and 34E extend in the radial direction of the transfer drum 30, and are movable in the radial direction of the transfer drum 30. The support portions 34D and 34E are urged toward the rotation center of the transfer drum 30 (from the outer periphery toward the inner periphery) by springs 37A and 37B that are attached to the shaft portions 34A and 34B, respectively.

Through holes 34F and 34G that extend in the Z direction are formed in the shaft portions 34A and 34B, and plate-shaped pushing members 39A and 39B are inserted through the through holes 34F and 34G, respectively.

The pushing members 39A and 39B are rotatable around the rotating shaft 31A together with the support members 34D and 34E. The pushing members 39A and 39B may be moved in the Z direction by operating solenoids (not shown). The support members 34D and 34E are moved in the radial direction of the transfer drum 30 when the pushing members 39A and 39B are moved in the Z direction (in the opposite directions). The support members 34D and 34E and the pushing members 39A and 39B have end faces that are inclined (tapered) with respect to a horizontal or vertical plane at an angle of 45°, and are arranged such that the end faces contact each other.

As illustrated in FIG. 3A, when the pushing members 39A and 39B are moved toward the transfer drum 30 in the Z direction, the support members 34D and 34E, which are respectively in contact with the pushing members 39A and 39B, are moved upward and outward in the radial direction of the cylindrical portion 31. Accordingly, the gap between the paper retainer 34C and the outer peripheral surface 31E of the cylindrical portion 31 is increased so as to form an opening.

As illustrated in FIG. 3B, when the pushing members 39A and 39B are moved away from the transfer drum 30, the support members 34D and 34E are moved downward and inward in the radial direction of the cylindrical portion 31. Accordingly, the gap between the paper retainer 34C and the outer peripheral surface 31E of the cylindrical portion 31 is reduced and the sheet of recording paper P that is wrapped around the outer peripheral surface 31E is retained.

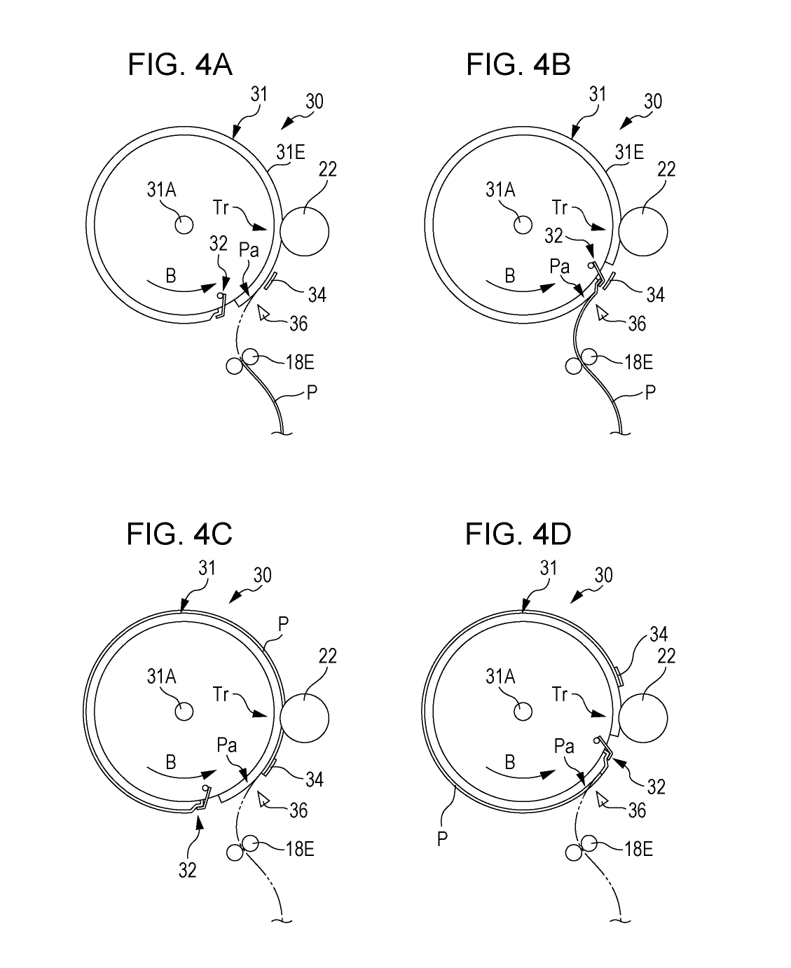

As illustrated in FIGS. 4A and 4B, the transfer drum 30 is rotated by the transfer-drum driver 50. The transfer-drum driver 50 includes a transfer-drum motor M1 that rotates the transfer drum 30 and a transfer-drum gear G1 that is connected to an end of the rotating shaft 31A and receives a driving force from the transfer-drum motor M1.

The trailing-end gripper 34 is rotated by a trailing-end-gripper driver 60, which is an example of a position adjusting unit. The trailing-end-gripper driver 60 includes a trailing-end-gripper motor M2 that rotates the shaft portion 34B of the trailing-end gripper 34 and a shaft-portion gear G2 that is provided on the outer peripheral surface of the shaft portion 34B and receives a driving force from the trailing-end-gripper motor M2.

### Thickness of Recording Paper P

Next, the relationship between the thickness of the sheet of recording paper P and the tension required to be applied to the trailing-end gripper 34 will be described.

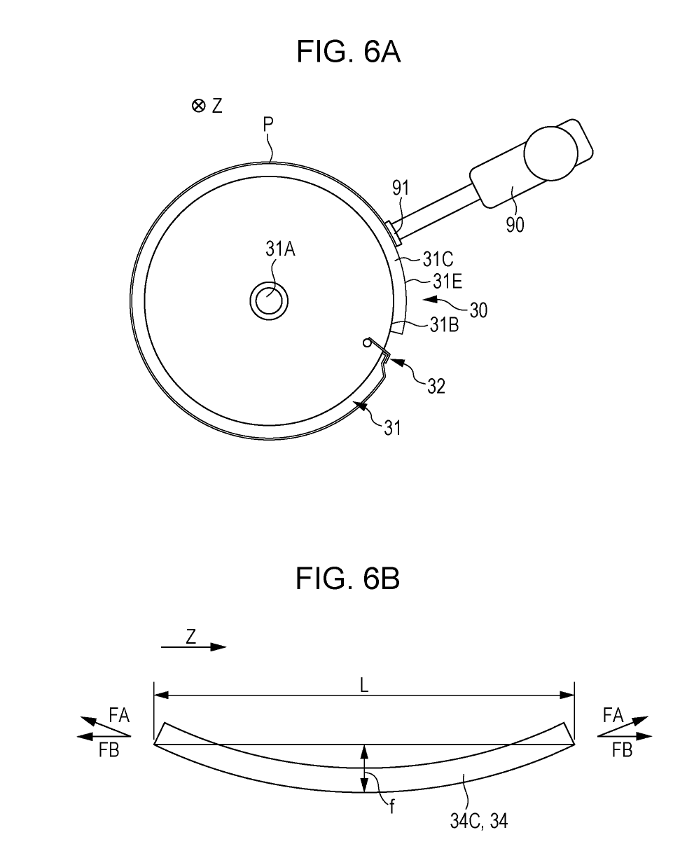

FIG. 6A illustrates the manner in which a spring-back force of the trailing end of the sheet of recording paper P is measured by using a push-pull gauge 90. The sheet of recording paper P is wrapped around the outer peripheral surface 31E of the transfer drum 30 while the leading end thereof is held by the leading-end gripper 32 and the trailing end thereof is not retained.

The push-pull gauge 90 (Digital force gauge ZPS with a separate sensor manufactured by Imada Co., Ltd.) includes a detector portion 91 that receives load. The detector portion 91 is pushed against the trailing end of the sheet of recording paper P, and the load applied when the trailing end of the sheet of recording paper P comes into contact with the outer peripheral surface 31E of the transfer drum 30 is measured as a spring-back force (unit: N).

FIG. 6B is a schematic diagram illustrating the paper retainer 34C of the trailing-end gripper 34. Assume that uniformly distributed load co is applied to the paper retainer 34C. When the amount of deflection of the paper retainer 34C at the center of the paper retainer 34C in the width direction (Z direction) is f, the length of the paper retainer 34C in the width direction is L, and the concentrated load is Q, the horizontal component FB of the tension of the paper retainer 34C at each end thereof in the width direction is calculated as FB=(((ωL/2)+Q)×L)/4f.

Here, it is assumed that the amount of deflection f of the paper retainer 34C corresponds to the separation distance of the sheet of recording paper P (distance by which the sheet of recording paper P springs back). Since the amount of deflection f is sufficiently small compared to the length L of the paper retainer 34C, it is assumed that the horizontal component FB of the tension of the paper retainer 34C is equal to the tension FA required to suppress the deflection of the paper retainer 34C. In addition, the paper retainer 34C does not receive any concentrated load, Q is equal to 0. In addition, ωL corresponds to the spring-back force that is F applied by the trailing end of the sheet of recording paper P. In this case, the tension required to suppress the deflection of the paper retainer 34C is calculated as FA=(F×L)/8f.

Accordingly, when the separation distance of the sheet of recording paper P (distance by which the sheet of recording paper P springs back) is f, the length of the paper retainer 34C in the Z direction is L, and the spring-back force applied by the trailing end of the sheet of recording paper P is F, the tension FA of the trailing-end gripper 34 required to retain the trailing end of the sheet of recording paper P that tries to spring back is calculated as FA=(F×L)/8f.

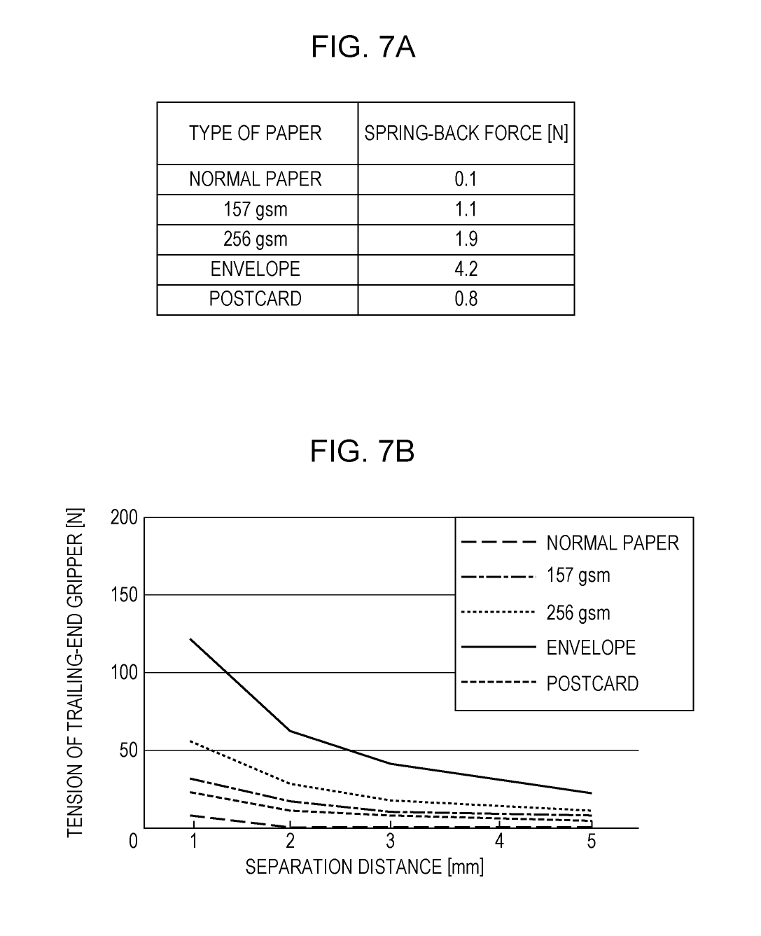

FIG. 7A is a table showing the measurement values of the spring-back force when the sheet of recording paper P is a sheet of normal paper (64 gsm), a sheet of thick paper A (157 gsm), a sheet of thick paper B (256 gsm), an envelope, and a postcard. The measurement of the spring-back force is performed by the method illustrated in FIG. 6A.

FIG. 7B is a graph showing the relationship between the separation distance f (mm) of the sheet of recording paper P and the tension FA (N) of the trailing-end gripper 34 calculated from the data of the spring-back force in the table of FIG. 7A using the equation FA=(F×L)/8f of the tension FA of the trailing-end gripper 34. Referring to this graph, the tension FA required to be applied to the trailing-end gripper 34 (see FIG. 2A) may be determined from the type (thickness, shape) of the sheet of recording paper P and the separation distance of the sheet of recording paper P. In the present exemplary embodiment, the tension of the trailing-end gripper 34 is set in advance to a constant value (for example, 20 N) on the basis of the graph of FIG. 7B. The separation distance f is the distance by which the sheet of recording paper P springs back while being retained by the trailing-end gripper 34.

In the case where the tension of the trailing-end gripper 34 is constant, the manner in which the trailing end of the sheet of recording paper P is retained by the trailing-end gripper 34 changes when the thickness of the sheet of recording paper P is changed or when the orientation of an envelope is changed. Accordingly, in the present exemplary embodiment, as described below, the position at which the trailing-end gripper 34 retains the sheet of recording paper P in the circumferential direction is changed (adjusted) for each of the sheets of recording paper P having different thicknesses. Specifically, if the tension required when the separation distance of the sheet of recording paper P is small (when the sheet of recording paper P is retained at a position near the trailing end thereof) is high in FIG. 7B, the trailing-end gripper 34 is shifted so as to increase the separation distance, so that the sheet of recording paper P may be retained at a constant tension.

### Setting Panel

A setting panel 70 will now be described.

Referring to FIG. 1, the setting panel 70 is provided on the top surface of the housing 10A. The setting panel 70 allows the user to operate and set the image forming apparatus 10. As illustrated in FIG. 5B, the setting panel 70 includes, for example, a touch panel 72.

The touch panel 72 includes a thickness selecting region 72A which allows the user to select the thickness of the sheet of recording paper P to be used and a size selecting region 72B which allows the user to select the size of the sheet of recording paper P to be used. The thickness selecting region 72A displays, for example, six types of selecting buttons for normal paper (60 gsm or more and 105 gsm or less), envelope (horizontally orientated), envelope (vertically oriented), thick paper A (more than 105 gsm and 163 gsm or less), thick paper B (more than 163 gsm and 256 gsm or less), and postcard. In the present exemplary embodiment, when, for example, a sheet of normal paper is used, the trailing-end gripper 34 (see FIG. 2A) is disposed at a position corresponding to the trailing end of the sheet of normal paper. In other words, normal paper is set as a reference medium.

The size selecting region 72B displays plural size selecting buttons which allow the user to select the size of the sheet of recording paper P to be used. Although A4, A3, and B5 are displayed as examples of sizes in FIG. 5B, the sizes are not limited to this, and other sizes may instead be displayed.

As illustrated in FIG. 5A, the setting panel 70 (the unit including the setting panel 70) includes a thickness determination unit 74 and an envelope determination unit 76. The thickness determination unit 74 is an example of a determination unit that determines the thickness of the sheet of recording paper P on which an image is to be formed. The envelope determination unit 76 is an example of an envelope determination unit that determines the orientation of the open side (flap) of the envelope.

When one of the selecting buttons for normal paper, thick paper A, thick paper B, envelope-horizontal, envelope-vertical, and postcard on the touch panel 72 (see FIG. 5B) is pressed, the thickness determination unit 74 transmits information (signal) of the selected type of recording paper to the controller 100. The envelope determination unit 76 determines the orientation of an envelope. When one of the selecting buttons for envelope-horizontal (horizontally oriented) and envelope-vertical (vertically oriented) on the touch panel 72 is pressed, the envelope determination unit 76 transmits the orientation information (signal) of the selected type of envelope to the controller 100.

### Controller

The controller 100 will now be described.

Referring to FIG. 5A, the controller 100 receives the information of the thickness of the sheet of recording paper P and the information of the orientation of the envelope from the setting panel 70. The controller 100 also receives an image signal from the inside or outside of the image forming apparatus 10 (see FIG. 1), and the signal of passage of the sheet of recording paper P and a signal of phase of the photoconductor drum 22 (see FIG. 1) from the paper detection sensor 36 (see FIG. 1).

The controller 100 includes a trailing-end-gripper position determination unit 78 and a transfer-area limiting unit 82. The trailing-end-gripper position determination unit 78 determines the position at which the trailing-end gripper 34 (see FIG. 2A) is to retain the sheet of recording paper P in accordance with the selected type of recording paper P. The transfer-area limiting unit 82 limits the transfer area of the toner image on the sheet of recording paper P on the basis of the position of the trailing-end gripper 34 determined by the trailing-end-gripper position determination unit 78 (changed by the trailing-end-gripper driver 60).

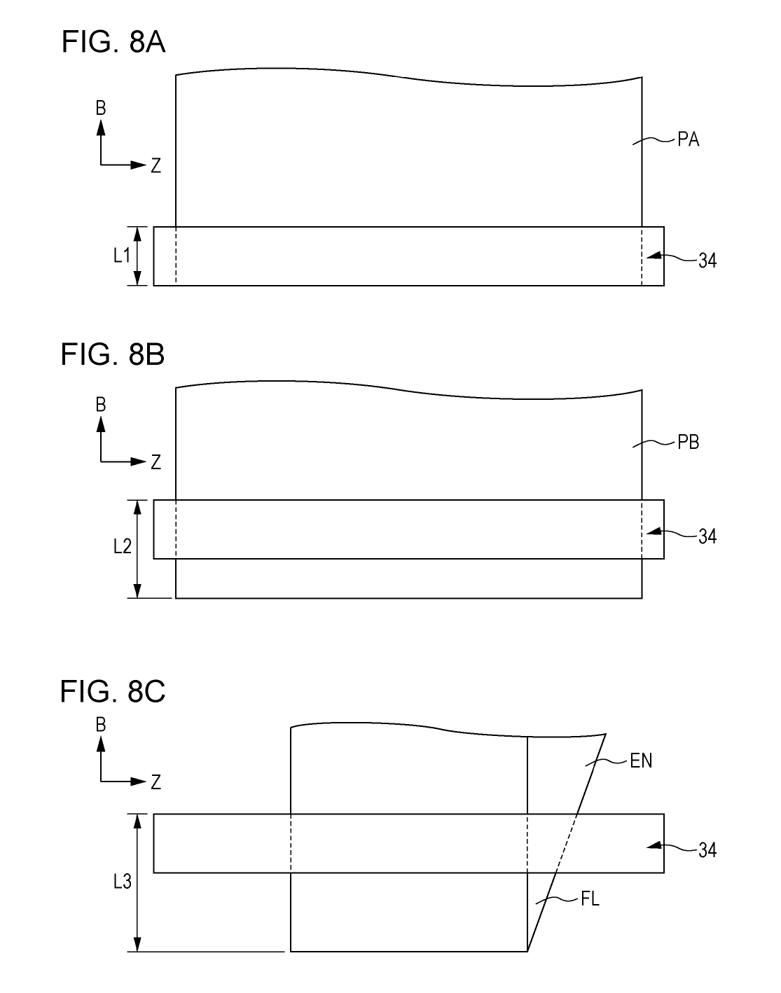

In the case where the sheet of recording paper P whose thickness is determined by the thickness determination unit 74 is a sheet of thick paper (A or B) that has a thickness greater than that of a sheet of normal paper, which is the reference medium, the trailing-end-gripper position determination unit 78 operates the trailing-end-gripper driver 60 as follows. That is, the trailing-end-gripper driver 60 is operated so that a second distance L2 (see FIG. 8B) is longer than a first distance L1 (see FIG. 8A), the first distance L1 being the distance between the trailing end of the sheet of normal paper and the trailing-end gripper 34 (see FIG. 1) in the circumferential direction of the transfer drum 30 (see FIG. 1) (hereinafter referred to as B direction) in the case where the sheet of normal paper is used, and the second distance L2 being the distance between the trailing end of the sheet of thick paper and the trailing-end gripper 34 in the B direction. Here, it is assumed that the sheet of normal paper and the sheet of thick paper have the same size.

FIG. 8A illustrates the position of the trailing-end gripper 34 in the case where a sheet of normal paper PA is wrapped around the transfer drum 30 (see FIG. 1). When the sheet of recording paper P is the sheet of normal paper PA, the trailing-end gripper 34 retains the sheet of normal paper PA at a position where the trailing end of the trailing-end gripper 34 substantially coincides with the trailing end of the sheet of normal paper PA. Here, the first distance L1 is the distance between the trailing end of the sheet of normal paper PA and the leading end of the trailing-end gripper 34 in the B direction.

FIG. 8B illustrates the position of the trailing-end gripper 34 in the case where a sheet of thick paper PB (the above-described thick paper B) is wrapped around the transfer drum 30 (see FIG. 1). When the sheet of recording paper P is the sheet of thick paper PB, the trailing-end gripper 34 retains the sheet of thick paper PB at a position where the trailing end of the trailing-end gripper 34 is separated from the trailing end of the sheet of thick paper PB in the B direction. Here, the second distance L2 is the distance between the trailing end of the sheet of thick paper PB and the leading end of the trailing-end gripper 34 in the B direction, and L2>L1 is satisfied. In the present exemplary embodiment, for example, L1=3 mm and L2=7 mm. The width of the trailing-end gripper 34 (paper retainer 34C) in the B direction is, for example, 3 mm.

Referring to FIG. 5A, when the thickness determination unit 74 determines that the sheet of recording paper P is an envelope, the trailing-end-gripper position determination unit 78 operates the trailing-end-gripper driver 60 so that a third distance L3 is greater than the second distance L2, the third distance L3 being the distance between the trailing end of the envelope and the leading end of the trailing-end gripper 34 in the B direction when the envelope is used.

FIG. 8C illustrates the position of the trailing-end gripper 34 in the case where an envelope EN is wrapped around the transfer drum 30 (see FIG. 1) while a flap FL of the envelope EN is positioned such that the envelope EN opens in the Z direction (hereinafter referred to as a vertically oriented state). When the sheet of recording paper P is the envelope EN, the trailing-end gripper 34 retains the envelope EN at a position where the trailing end of the trailing-end gripper 34 is separated from the trailing end of the envelope EN in the B direction. Here, the third distance L3 is the distance between the trailing end of the envelope EN and the leading end of the trailing-end gripper 34 in the B direction. In the present exemplary embodiment, for example, L3>L2>L1 is satisfied.

Referring to FIG. 5A, in the case where the orientation of the open side of the envelope that is determined by the envelope determination unit 76 is such that the open side is along the B direction, the controller 100 operates the trailing-end-gripper driver 60 so that the position of the trailing-end gripper 34 (see FIG. 1) is farter from the leading-end gripper 32 (see FIG. 1) in the B direction than that in the case where the envelope EN is vertically oriented.

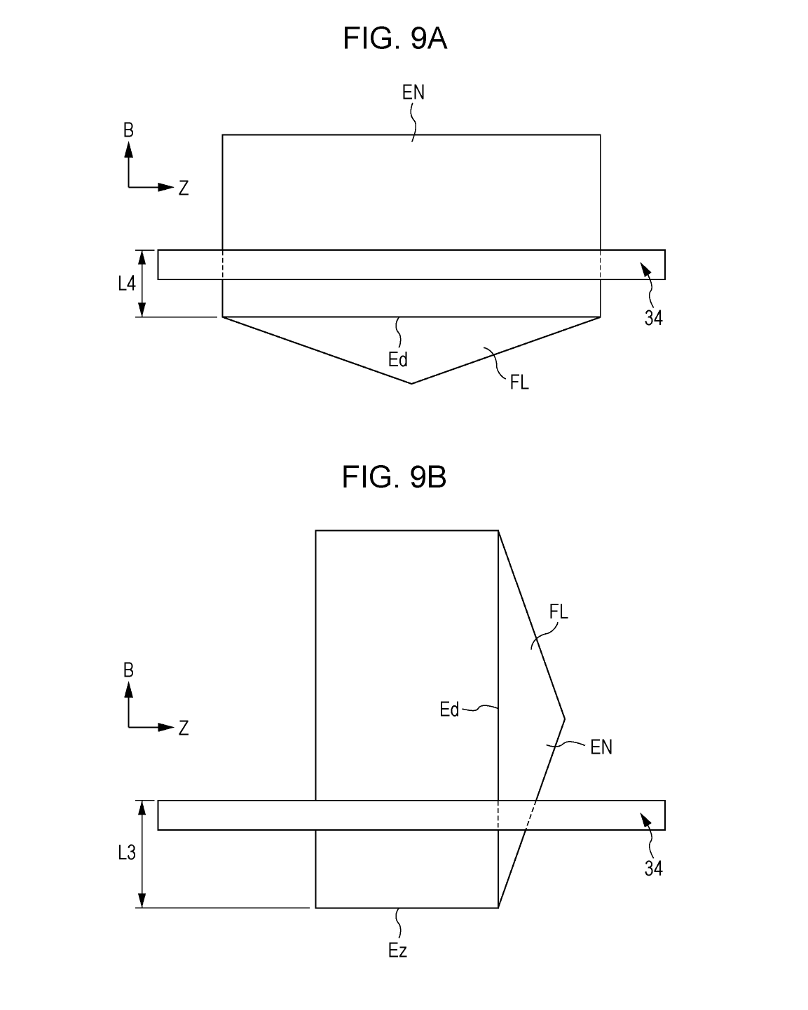

FIG. 9A illustrates the state in which the flap FL of the envelope EN is oriented upstream in the B direction and the open side Ed of the envelope EN (which corresponds to the folding line of the flap FL) is along the Z direction. In this state, the trailing-end gripper 34 retains the envelope EN at a position where the trailing end of the trailing-end gripper 34 is separated from the open side Ed of the envelope EN in the B direction. A fourth distance L4 is the distance between the open side Ed of the envelope EN and the leading end of the trailing-end gripper 34 in the B direction. In the present exemplary embodiment, for example, L3>L4>L2>L1 is satisfied. In addition, in the present exemplary embodiment, for example, L3=10 mm, and L4=8 mm.

FIG. 9B illustrates the state in which the flap FL of the envelope EN is oriented in the Z direction and the open side Ed of the envelope EN is along the B direction. In this state, the trailing-end gripper 34 retains the envelope EN at a position where the trailing end of the trailing-end gripper 34 is separated from the trailing end Ez of the envelope EN in the B direction. As described above, the third distance L3 is the distance between the trailing end Ez of the envelope EN and the leading end of the trailing-end gripper 34 in the B direction.

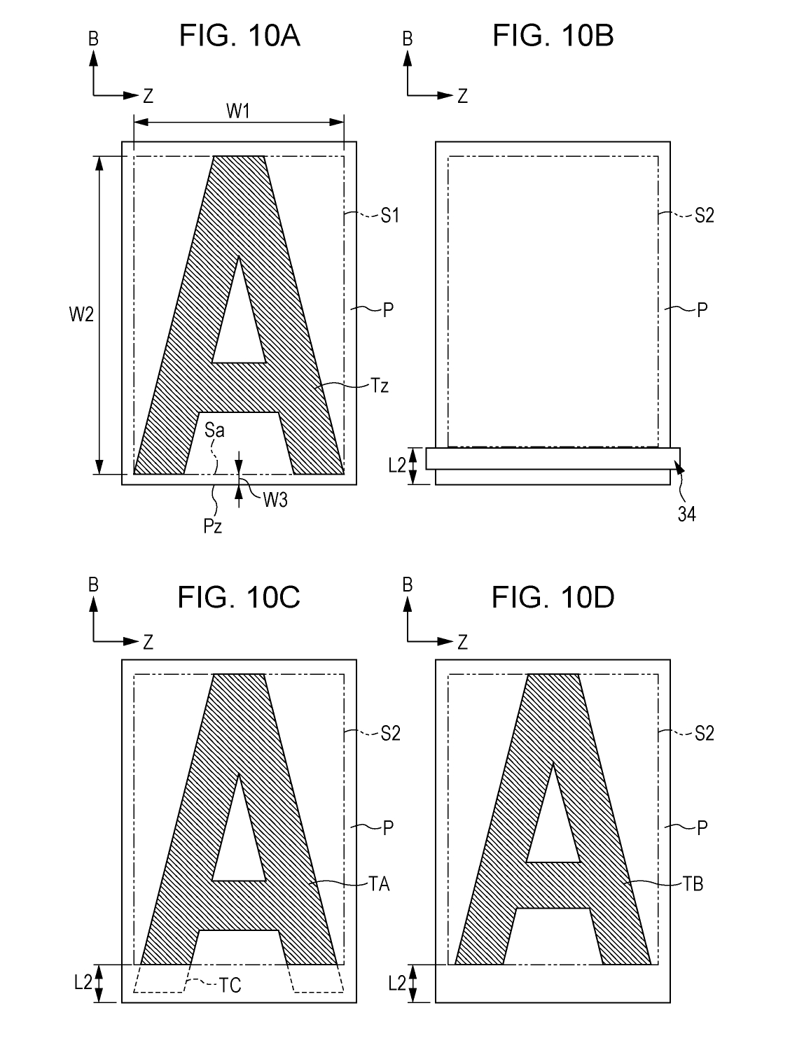

FIG. 10A illustrates an example of a transfer area S1 of a toner image on the sheet of recording paper P. The transfer area S1 has a rectangular shape whose width in the Z direction is W1 and whose width in the B direction is W2 (>W1). The distance between the trailing end Sa of the transfer area S1 and the trailing end Pz of the sheet of recording paper P in the B direction is W3. Namely, a margin whose width in the B direction is W3 (for example, 4 mm) is provided. In FIG. 10A, an image having the shape of letter ‘A’ is formed in the transfer area S1 as an example of a toner image Tz. The toner image Tz is in contact with the border of the transfer area S1.

Referring to FIG. 5A, the transfer-area limiting unit 82 limits the transfer area of the toner image on the sheet of recording paper P on the basis of the position of the trailing-end gripper 34 (see FIG. 1) changed by the trailing-end-gripper driver 60 (determined by the trailing-end-gripper position determination unit 78).

More specifically, assume that the position of the trailing-end gripper 34 with respect to the sheet of recording paper P is determined such that the distance between the trailing end of the sheet of recording paper P and the leading end of the trailing-end gripper 34 is L2, as illustrated in FIG. 10B. In this case, the transfer-area limiting unit 82 (see FIG. 5A) changes the transfer area of the toner image from S1 to S2. The controller 100 (see FIG. 5A) controls the processes of forming an electrostatic latent image on the photoconductor drum 22 (see FIG. 1), developing the image, and transferring the image in accordance with a mode for cutting the trailing end of the image (see FIG. 10C) or a mode for reducing the image (see FIG. 10D).

Referring to FIG. 1, the controller 100 outputs control signals to the following parts. That is, the controller 100 outputs control signals to a photoconductor-drum driver (not shown) that rotates the photoconductor drum 22; the charging device 24; the exposure device 26; a developing-device driver (not shown) that places the desired one of the developing units 28Y, 28M, 28C, and 28K at a developing position, at which the developing device 28 faces the photoconductor drum 22, by rotating and stopping the developing device 28; a developing-bias setting unit (not shown) that sets a developing bias supplied to one of the developing units 28Y, 28M, 28C, and 28K that is placed at the developing position; the transfer-drum driver 50 (see FIG. 3A); the trailing-end-gripper driver 60 (see FIG. 3A) that rotates the trailing-end gripper 34; the transfer-bias applying unit 33; the leading-end gripper 32; trailing-end gripper 34; the paper feed unit 18; and the fixing device 16.

### Image Forming Operation Performed by Image Forming Apparatus 10

An image forming operation performed by the image forming apparatus 10 (see FIG. 1) will now be described. As an example, a case will be described in which the image forming apparatus 10 forms a multicolor image on a single sheet of recording paper P.

In the image forming apparatus 10 illustrated in FIG. 1, a color reflected light image of a document read by a document reading device (not shown) or color image data generated by a personal computer (not shown) is input to an image signal processor 84 (see FIG. 5A) as, for example, red (R), green (G), and blue (B) image data and is subjected to predetermined image processing. The image data that has been subjected to image processing is converted into color gradation data of four colors, which are yellow (Y), magenta (M), cyan (C), and black (K), and is output to the exposure device 26.

When the image forming operation is started, the photoconductor drum 22 and the transfer drum 30 rotate in synchronization with each other, more specifically, such that the transfer drum 30 rotates at a peripheral speed that is slightly different from that of the photoconductor drum 22. At this time, the leading-end gripper 32 and the trailing-end gripper 34 are both in the open state. The leading-end gripper 32 rotates together with the transfer drum 30. The trailing-end gripper 34 is stationary at the standby position and does not rotate together with the transfer drum 30. In other words, the peripheral speed of the trailing-end gripper 34 is zero. More specifically, referring to FIG. 4A, the trailing-end gripper 34 is arranged so as to face the outer peripheral surface of the transfer drum 30 at a position between the paper feed position Pa and the transfer region Tr.

Next, referring to FIG. 1, the photosensitive layer 22A of the photoconductor drum 22 that rotates is charged by the charging device 24, and the exposure device 26 irradiates the photoconductor drum 22 with light so that an electrostatic latent image of the first color (for example, yellow) that corresponds to the image information is formed. When the transfer drum 30 starts to rotate, the paper detection sensor 36 starts measuring the rotational position of the transfer drum 30. The measured rotational position is transmitted to the controller 100.

In the developing device 28, the developing unit containing color toner that corresponds to the electrostatic latent image formed on the photoconductor drum 22 (the yellow developing unit 28Y when the first color is yellow) is moved to and stopped at the position at which the developing unit faces the photoconductor drum 22 in advance. The developing unit 28Y develops the electrostatic latent image on the photoconductor drum 22, so that the toner image T is formed on the photoconductor drum 22. The toner image T (yellow toner image in this case) is transported to the transfer region Tr, in which the photoconductor drum 22 faces the transfer device 14, as the photoconductor drum 22 rotates.

When the image forming operation is started, feeding of the sheet of recording paper P is also started. More specifically, the sheet of recording paper P is picked up from the paper container 18A by the pick-up roller 18B, is caused to pass through the separation rollers 18C, and is transported along the feed path 40 by the transport rollers 18E. When the paper detection sensor 36 detects passage of the leading end of the sheet of recording paper P in the transporting direction, the paper detection sensor 36 outputs a detection signal to the controller 100. Upon receiving the detection signal, the controller 100 controls, on the basis of the detection signal and phase obtained by the paper detection sensor 36, the transportation of the sheet of recording paper P so that the sheet of recording paper P reaches the paper feed position Pa at the time when the leading-end gripper 32 reaches the paper feed position Pa.

Then, as illustrated in FIG. 4B, the state of the leading-end gripper 32 is changed from the open state to the closed state at the paper feed position Pa. As a result, the leading end portion of the sheet of recording paper P in the transporting direction is held by the leading-end gripper 32. At this time, the trailing-end gripper 34 is arranged so as to face the outer peripheral surface of the transfer drum 30 and is stationary at the standby position. The leading-end gripper 32 that holds the sheet of recording paper P passes through the space between the trailing-end gripper 34 in the stationary state and the rotating shaft 31A of the transfer drum 30.

After passing through the space between the trailing-end gripper 34 and the rotating shaft 31A, the leading-end gripper 32 passes through the transfer region Tr while holding the sheet of recording paper P. The sheet of recording paper P that has passed through the transfer region Tr is transported along the rotating path 43 (see FIG. 1) while being held by the leading-end gripper 32 and wrapped around the outer peripheral surface 31E of the transfer drum 30.

Subsequently, referring to FIG. 1, the paper detection sensor 36 detects passage of the trailing end of the sheet of recording paper P in the transporting direction after the electrostatic latent image of the first color (for example, yellow) that corresponds to the image information is formed on the photoconductor drum 22 by the exposure device 26. The paper detection sensor 36 transmits a detection signal to the controller 100, which then transmits an instruction to the trailing-end gripper 34. Upon receiving the instruction, the trailing-end gripper 34 changes the state thereof from the open state to the closed state (see arrow D1 in FIG. 3A).

Then, as illustrated in FIG. 4C, the trailing-end gripper 34 in the closed state starts to rotate in synchronization with the transfer drum 30. In other words, the sheet of recording paper P rotates together with the transfer drum 30 while the leading end portion thereof in the transporting direction is held by the leading-end gripper 32 and the trailing end portion thereof in the transporting direction is retained by the trailing-end gripper 34. The toner image of the first color (for example, yellow) formed on the photoconductor drum 22 is transferred onto the sheet of recording paper P on the transfer drum 30 in the transfer region Tr in which the photoconductor drum 22 and the transfer drum 30 face each other. The toner that remains on the photoconductor drum 22 after the transfer process is removed by the cleaning device 46 (see FIG. 1).

Subsequently, the latent-image forming process, the developing process, and the transfer process for the second color to the second-from-last color (for example, for magenta and cyan in that order) are performed in accordance with the above-described sequence. In the process of forming the toner image T of each color, the developing device 28 (see FIG. 1) is rotated so as to move the corresponding developing unit 28M or 28C (see FIG. 1) to the stop position. Meanwhile, as illustrated in FIG. 4D, the sheet of recording paper P is rotated and transported while being wrapped around the transfer drum 30 by the leading-end gripper 32 and the trailing-end gripper 34. Each time the sheet of recording paper P passes through the transfer region Tr, the toner image of one of the second and the following colors is transferred onto the sheet of recording paper P in a superimposed manner. As a result, the toner images of colors other than black (K), that is, yellow (Y), magenta (M), and cyan (C) toner images, are transferred onto the sheet of recording paper P on the transfer drum 30 in a superimposed manner.

When the toner image T of the last color (for example, black) is transferred, unlike the process of transferring the toner images of the other colors, the state of the leading-end gripper 32 is changed from the closed state to the open state after the sheet of recording paper P has passed through the transfer region Tr. Accordingly, the sheet of recording paper P is released from the leading-end gripper 32. Then, referring to FIG. 1, the leading end of the sheet of recording paper P, on which a color image has been formed, in the transporting direction is separated from the transfer drum 30 and is guided into the output path 41 from a paper release position Pb.

Subsequently, as the sheet of recording paper P is further transported, the trailing-end gripper 34, which retains the trailing end of the sheet of recording paper P in the transporting direction, changes the state thereof from the closed state to the open state (see arrow D2 in FIG. 3A). The trailing-end gripper 34 changes the state thereof from the closed state to the open state while or after the electrostatic latent image of the last color (for example, black) that corresponds to the image information is formed by the exposure device 26. The trailing-end gripper 34 in the open state stops at the standby position.

Subsequently, the trailing end of the sheet of recording paper P in the transporting direction, which has been released from the trailing-end gripper 34, is separated from the transfer drum 30 and is guided into the output path 41 from the paper release position Pb. The sheet of recording paper P that has been guided into the output path 41 is transported to the fixing device 16, where the toner images T are fixed by the heating roller 16A and the pressing roller 16B. After the fixing process, the sheet of recording paper P is discharged to the outside of the image forming apparatus 10 by the paper output rollers 44 and is placed on the paper receiver 42.

Next, a comparative example will be described.

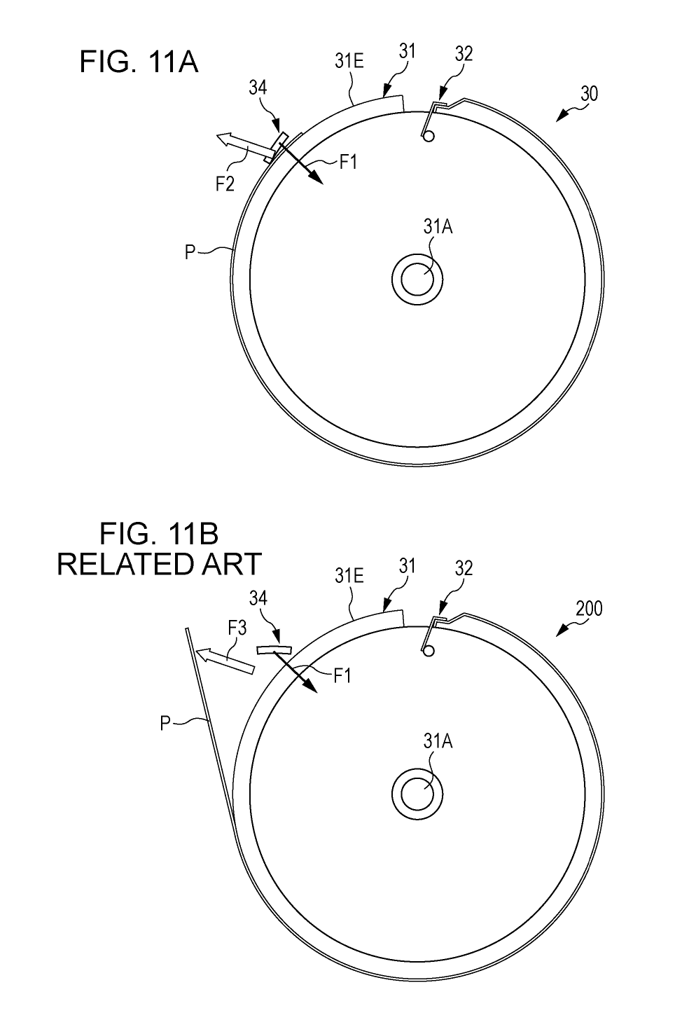

FIG. 11B illustrates a transfer drum 200 that does not change the position of the trailing-end gripper 34 in the circumferential direction in accordance with the thickness of the sheet of recording paper P. Even when the sheet of recording paper P is changed from a sheet of normal paper to a sheet of thick paper or an envelope, the position at which the sheet of recording paper P is retained by the trailing-end gripper 34 on the transfer drum 200 is not changed. Therefore, when the sheet of thick paper or the envelope is retained by applying the same retaining force F1 as that in the case of the sheet of normal paper, the reactive force F3 of the sheet of recording paper P in the wrapped state may become greater than the retaining force F1 of the trailing-end gripper 34. In such a case, the trailing end of the sheet of recording paper P will be released from the transfer drum 200.

Conversely, if the retaining force F1 of the trailing-end gripper 34 is increased so that the sheet of recording paper P may be retained on the transfer drum 200 even when the sheet of recording paper P is the sheet of thick paper or the envelope, the trailing end of the sheet of recording paper P cannot be moved in the circumferential direction of the transfer drum 200 when the sheet of recording paper P is the sheet of normal paper. As a result, displacement or separation of the leading end of the sheet of recording paper P may occur and the sheet of recording paper P may become wrinkled.

### Operation

The operation of the present exemplary embodiment will now be described.

Referring to FIGS. 5A and 11A, when the sheet of recording paper P is changed from a sheet of normal paper to a sheet of thick paper or an envelope in the image forming apparatus 10, the thickness determination unit 74 detects the change. Accordingly, the controller 100 (the trailing-end-gripper position determination unit 78) operates the trailing-end-gripper driver 60 so as to move the trailing-end gripper 34 toward the leading-end gripper 32 in the circumferential direction from the position for the sheet of normal paper so that the distance between the trailing end of the sheet of recording paper P and the leading end of the trailing-end gripper 34 is set to L2 or L3. As a result, the reactive force F2 (spring-back force) of the sheet of recording paper P in the wrapped state with respect to the retaining force F1 of the trailing-end gripper 34 becomes smaller than the reactive force F3 (see FIG. 11B) according to the comparative example. Thus, the trailing end of the sheet of recording paper P is prevented from being released from the transfer drum 30.

Specifically, referring to FIGS. 5A, 8A, and 8B, when the sheet of recording paper P is changed from a sheet of normal paper to a sheet of thick paper in the image forming apparatus 10, the thickness determination unit 74 detects the change. Accordingly, the controller 100 (the trailing-end-gripper position determination unit 78) operates the trailing-end-gripper driver 60 so as to increase the distance between the trailing end of the sheet of recording paper P and the leading end of the trailing-end gripper 34 from L1 to L2. Thus, the trailing-end gripper 34 is capable of resisting the reactive force of the sheet of thick paper without changing the tension thereof. As a result, the trailing end of the sheet of thick paper may be appropriately retained.

Similarly, referring to FIGS. 5A, 8A, 8B, and 8C, when the sheet of recording paper P is changed from a sheet of normal paper to an envelope or from a sheet of thick paper to the envelope in the image forming apparatus 10, the thickness determination unit 74 detects the change. Accordingly, the controller 100 (the trailing-end-gripper position determination unit 78) operates the trailing-end-gripper driver 60 so as to increase the distance between the trailing end of the sheet of recording paper P and the leading end of the trailing-end gripper 34 from L1 to L3 or from L2 to L3. Thus, the trailing-end gripper 34 is capable of resisting the reactive force of the envelope without changing the tension thereof. As a result, the trailing end of the envelope may be appropriately retained.

In the image forming apparatus 10, it is not necessary to increase the retaining force F1 of the trailing-end gripper 34 in accordance with the thickness of the sheet of recording paper P. Therefore, even when the sheet of recording paper P is a sheet of normal paper, the trailing end of the sheet of recording paper P is movable in the circumferential direction of the transfer drum 30. Thus, the possibility that the displacement or separation of the leading end of the sheet of recording paper P will occur or the sheet of recording paper P will be wrinkled may be reduced. As described above, in the image forming apparatus 10 according to the present exemplary embodiment, the sheets of sheet of recording paper P having different thicknesses may be appropriately retained without replacing the trailing-end gripper 34.

In addition, referring to FIGS. 5A, 9A, and 9B, in the image forming apparatus 10, when the sheet of recording paper P is an envelope and the envelope may be oriented vertically or horizontally with respect to the transporting direction thereof, the envelope determination unit 76 determines the orientation of the envelope. Accordingly, the controller 100 (trailing-end-gripper position determination unit 78) operates the trailing-end-gripper driver 60 so as to set the distance between the trailing end of the envelope and the leading end of the trailing-end gripper 34 to L3 or L4, so that the trailing end of the envelope is movably retained.

Referring to FIGS. 5A, 10A, 10B, and 10C, in the image forming apparatus 10 (see FIG. 1) according to the present exemplary embodiment, assume that the distance between the trailing end of the sheet of recording paper P and the leading end of the trailing-end gripper 34 is increased to, for example, the distance L2 from that in the case of a sheet of normal paper. In this case, the transfer-area limiting unit 82 instructs the image data processor 84 to form a toner image TA obtained by removing a toner image TC (shown by dashed lines) that overlaps the area corresponding to the distance L2 from the toner image Tz. Thus, the trailing-end gripper 34 is prevented from being soiled by the toner that has been expected to form the toner image TC and the sheet of recording paper P on which the toner image is to be transferred next is prevented from being soiled by the toner that has adhered to the trailing-end gripper 34.

In addition, referring to FIGS. 5A, 10A, 10B, and 10D, in the image forming apparatus 10 (see FIG. 1) according to the present exemplary embodiment, assume that the distance between the trailing end of the sheet of recording paper P and the leading end of the trailing-end gripper 34 is increased to, for example, the distance L2 from that in the case of a sheet of normal paper. In this case, the transfer-area limiting unit 82 sets the area in which transferring may be performed to the transfer area S2 excluding the part that overlaps the area corresponding to the distance L2. The image data processor 84 forms a toner image TB by reducing the toner image TA so as to fit within the transfer area S2. Then, the image forming operation is performed on the basis of the toner image TB. Thus, the trailing-end gripper 34 is prevented from being soiled by the toner and the sheet of recording paper P on which the toner image is to be transferred next is prevented from being soiled by the toner that has adhered to the trailing-end gripper 34.

The present invention is not limited to the above-described exemplary embodiment.

The recording-medium transporting member is not limited to the transfer drum 30, and may instead be a transport roller that is used simply to transport the sheet of recording paper P. In addition, the image forming apparatus 10 is not limited to an electrophotographic image forming apparatus, and may instead be an apparatus that uses other image forming methods, such as an inkjet image forming apparatus.

The distance L between the trailing end of the sheet of recording paper P and the leading end of the trailing-end gripper 34 may be set for each of the thick paper A and the thick paper B.

The distance L may also be set in accordance with the length of the sheet of recording paper P in the B direction (transporting direction) and the width of the sheet of recording paper P in the Z direction (width direction), and the above-described operation may be performed also when the size of the sheet of recording paper P is changed.

In the case where the orientation of the envelope is not taken into consideration, the envelope determination unit 76 in the setting panel 70 of the image forming apparatus 10 may be omitted.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
an image carrier that is rotatably provided and carries a developer image;
a recording-medium transporting member that is rotatably provided so as to face the image carrier and that includes a holding portion that holds a leading end of a recording medium, the recording medium being wrapped around an outer peripheral surface of the recording-medium transporting member;
a retaining portion that switches between a state in which the retaining portion retains a trailing end portion of the recording medium that is wrapped around the recording-medium transporting member and a state in which the retaining portion does not retain the trailing end portion of the recording medium;
a position adjusting unit that adjusts a position at which the retaining portion retains the trailing end portion of the recording medium in a circumferential direction of the recording-medium transporting member;
a transfer unit that transfers the developer image carried by the image carrier onto the recording medium retained on the recording-medium transporting member;
a determination unit that determines a thickness of the recording medium; and
a control unit that performs a control for causing the retaining portion to retain the trailing end portion of the recording medium at a position adjusted by the position adjusting unit in accordance with the thickness of the recording medium determined by the determination unit.

2. The image forming apparatus according to claim 1,
wherein, when the recording medium whose thickness is determined by the determination unit is a sheet of thick paper that has a thickness greater than a thickness of a reference medium that serves as a reference, the control unit operates the position adjusting unit so that a second distance, which is a distance between a trailing end of the sheet of thick paper and the retaining portion in the circumferential direction, is greater than a first distance, which is a distance between a trailing end of the reference medium and the retaining portion in the circumferential direction in the case where the reference medium is used.

3. The image forming apparatus according to claim 2,
wherein the determination unit is capable of determining whether or not the recording medium is an envelope, and
wherein, when the determination unit determines that the recording medium is an envelope, the control unit operates the position adjusting unit so that a third distance, which is a distance between a trailing end of the envelope and the retaining portion in the circumferential direction, is greater than the second distance.

4. The image forming apparatus according to claim 1,
wherein the determination unit is capable of determining whether or not the recording medium is an envelope, and
wherein, when the determination unit determines that the recording medium is an envelope, the control unit operates the position adjusting unit so that a distance between a trailing end of the envelope and the retaining portion in the circumferential direction is greater than a distance between a trailing end of a reference medium that serves as a reference and the retaining portion in the circumferential direction in the case where the reference medium is used.

5. The image forming apparatus according to claim 3,
wherein an envelope determination unit is provided to determine an orientation of an open side of the envelope, and
wherein, when the orientation of the open side determined by the envelope determination unit is such that the open side is along the circumferential direction, the control unit operates the position adjusting unit so that a position of the retaining portion in the circumferential direction is closer to the holding portion than a position of the retaining portion in the case where the open side of the envelope is along a width direction that crosses the circumferential direction.

6. The image forming apparatus according to claim 4,
wherein an envelope determination unit is provided to determine an orientation of an open side of the envelope, and
wherein, when the orientation of the open side determined by the envelope determination unit is such that the open side is along the circumferential direction, the control unit operates the position adjusting unit so that a position of the retaining portion in the circumferential direction is closer to the holding portion than a position of the retaining portion in the case where the open side of the envelope is along a width direction that crosses the circumferential direction.

7. The image forming apparatus according to claim 1,
wherein a transfer-area limiting unit is provided to limit a transfer area in which the developer image is transferred onto the recording medium on the basis of the position of the retaining portion that is changed by the position adjusting unit.

8. The image forming apparatus according to claim 2,
wherein a transfer-area limiting unit is provided to limit a transfer area in which the developer image is transferred onto the recording medium on the basis of the position of the retaining portion that is changed by the position adjusting unit.

9. The image forming apparatus according to claim 3,
wherein a transfer-area limiting unit is provided to limit a transfer area in which the developer image is transferred onto the recording medium on the basis of the position of the retaining portion that is changed by the position adjusting unit.

10. The image forming apparatus according to claim 4,
wherein a transfer-area limiting unit is provided to limit a transfer area in which the developer image is transferred onto the recording medium on the basis of the position of the retaining portion that is changed by the position adjusting unit.

11. The image forming apparatus according to claim 5,
wherein a transfer-area limiting unit is provided to limit a transfer area in which the developer image is transferred onto the recording medium on the basis of the position of the retaining portion that is changed by the position adjusting unit.

12. The image forming apparatus according to claim 6,
wherein a transfer-area limiting unit is provided to limit a transfer area in which the developer image is transferred onto the recording medium on the basis of the position of the retaining portion that is changed by the position adjusting unit.
